(19) United States
(12) Patent Application Publication
(10) Pub. No.: US 2004/0015377 A1
(43) Pub. Date: Jan. 22, 2004

(54) Method for assessing software development maturity

(75) Inventor: John Hostetler, Southlake, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/194,168

(22) Filed: Jul. 12, 2002

(51) Int. Cl. G06F 17/60

(52) U.S. Cl. 705/7

(57) ABSTRACT

A self-assessment procedure for assessing a software engineering process for compliance, and improving the measured compliance, with the Carnegie Mellon SEI/CMM Software Maturity Model systematically steps through levels 2-4 of the model, and the various sub-levels, assessing the maturity of the process being assessed on a scale having three coarse levels of Not Implemented, Partially Implemented and Fully Implemented and seven categories at the next level of detail.

### TECHNICAL FIELD

The field of the invention is that of software engineering, in particular, the development and maintenance of a systematic approach to software process engineering in conformance with the Carnegie Mellon University's CMM Software Maturity Model.

### BACKGROUND OF THE INVENTION

The Capability Maturity Model^{R} (CMM) from Carnegie-Mellon Software Engineering Institute (SEI) is a well-known approach to software engineering that requires a considerable amount of overhead and is oriented toward the processes within a software development group, rather than to the level of development of a particular project.

Accordinig to the Software Engineering Institute Website:

“The CMM is organized into five maturity levels:

1) Initial

2) Repeatable

3) Defined

4) Managed

5) Optimizing

Each of these levels is further divided into sublevels.

The process levels and sublevels are not linked in the sense that a process can be at level 2 in one category and at level 4 in another.

Conventionally, a company will hire a certified consultant to assess its practices at a cost that typically ranges from $50,000. to $70,000.

Not only is there a considerable cash expenditure associated with the CMM Model, but the assessment process takes a substantial amount of time from the achievement of the project goals. Typically, the process will require a significant fraction of the team's resources for a month.

The SEI recommends that a project be assessed “as often as needed or required”, but the expense and time required to perform an assessment in typical fashion act as an obstacle to assessment. Lack of knowledge of the status of an organization's maturity is a problem in carrying out the objectives of the organization and furthermore carries risks of noncompliance with the requirements of government or other customer contracts.

The art has felt a need for an assessment process that is sufficiently economical and quick that it can be implemented frequently enough to guide the software development process.

### SUMMARY OF THE INVENTION

The invention relates to a method of assessing the application of a software management process implementing the CMM to a project, comprising the steps of:

a) Selecting an ith level of the CMM model; a jth sub-level in the ith level; and assigning a rating to each KPA in the jth sub-level reflecting the level of maturity of that KPA in the project being assessed;

b) Repeating step a) until all KPAs in the CMM have been assessed and corresponding ratings have been made; and

c) combining the ratings to represent an assessment of the project.

An aspect of the invention is the improvement of a process by:

a) Selecting an ith level of the CMM model; a jth sub-level in the ith level; and assigning a rating to each KPA in the jth sub-level reflecting the level of maturity of that KPA in the project being assessed;

b) Repeating step a) until all KPAs in the CMM have been assessed and corresponding ratings have been made; and

c) formulating and executing a plan to improve areas with lower ratings until all areas are satisfactory.

A feature of the invention is a focus on levels 2-5 of the CMM model.

Another feature of the invention is that the assessment focuses on the extent to which tested practices are implemented and institutionalized, rather than on “how mature” the practice is.

Another feature of the invention is, for a participant completing the appraisal, the interpretation of each key practice as: “To what level is the following activity or key practice being used within my project?”.

Another feature of the invention is the use of a set of three rating levels representing implementation not achieved, implementation achieved in some respects and implementation fully achieved: (divided into additional values) in responding to the implementation/institutionalization of key practices within each of the KPAs for Levels 2, 3, 4 and 5.

Another feature of the invention is that the rating values 1, 2, 3, 4, 5, 6 and 7 are looked upon as building blocks in implementing the key practices within each of the Key Process Areas: i.e. the 7th level can only be achieved if the 6th level and the 5th level, etc. have been achieved.

### BRIEF DESCRIPTION OF THE DRAWING

FIG. 1 shows a sample of a form used in the practice of the invention.

FIG. 2 shows schematically the steps in applying the invention to a software project.

FIG. 3 shows schematically the steps in the CMM model.

FIG. 4 shows schematically the steps in applying the invention to a single level of a software project.

### BEST MODE OF CARRYING OUT THE INVENTION

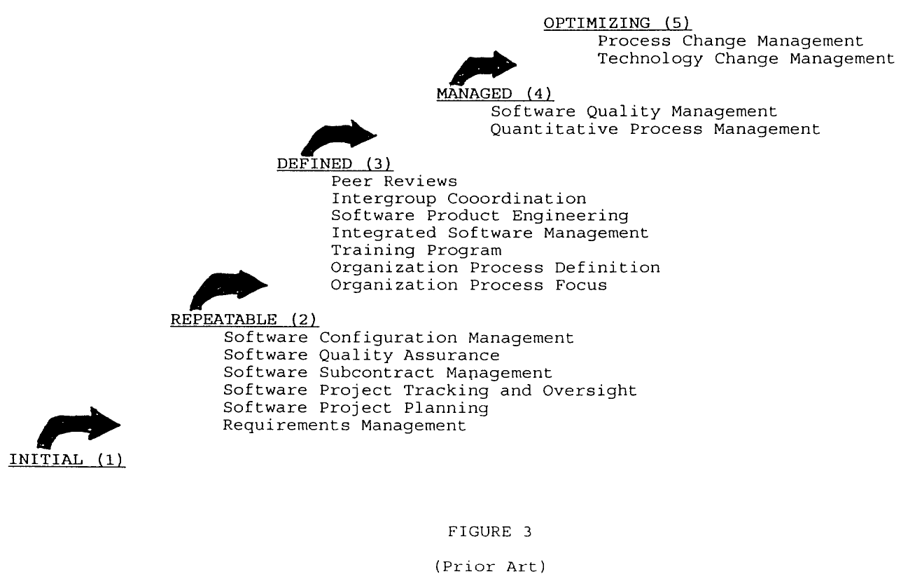

FIG. 3 shows a frequently duplicated chart illustrating the CMM. Within each of four levels, there are a number of topics that are to be implemented in a process according to the model. The designers of the model realized that not every project would follow every detail of the model.

Since the details of the model are not rigid, the process of assessing the compliance of procedures within a software group is not well defined.

The purpose of the procedure according to the invention is to establish the process for performing software interim profile assessments or appraisals for Levels 2, 3, 4 and 5 of the CMM within software organizations. The focus is on the SEI/CMM initiative surrounding the implementation and institutionalization of project and/or organizational processes. As used in this disclosure, “Institutionalization” means the building of infrastructures and corporate culture that support methods, practices and procedures so that they are continuously verified, maintained and improved. This and other definitions are found in Table I at the end of the disclosure.

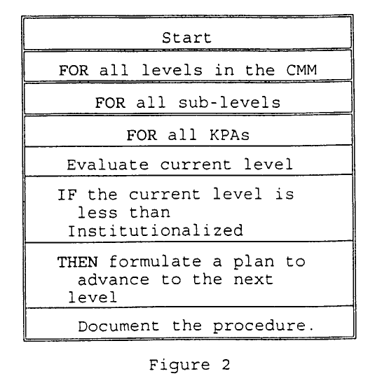

The inventive procedure is not only directed at assessment, but also at implementing improvement to the existing status. FIG. 2 illustrates in summary form the overall process, where the ratings are made on the following chart, taken from Table II below.

| | | Value | Meaning |
|---|---|---|---|
| | | NA | Not Applicable |
| | | 0 | Not Used/Not Documented |
| | | 1 | Know About |
| NS | {open oversize bracket} | 2 | Documented |
| | | 3 | Used |
| | | 4 | Measured |
| PS | {open oversize bracket} | 5 | Verified |
| | | 6 | Maintained |
| FS | | 7 | Continuously Improved |

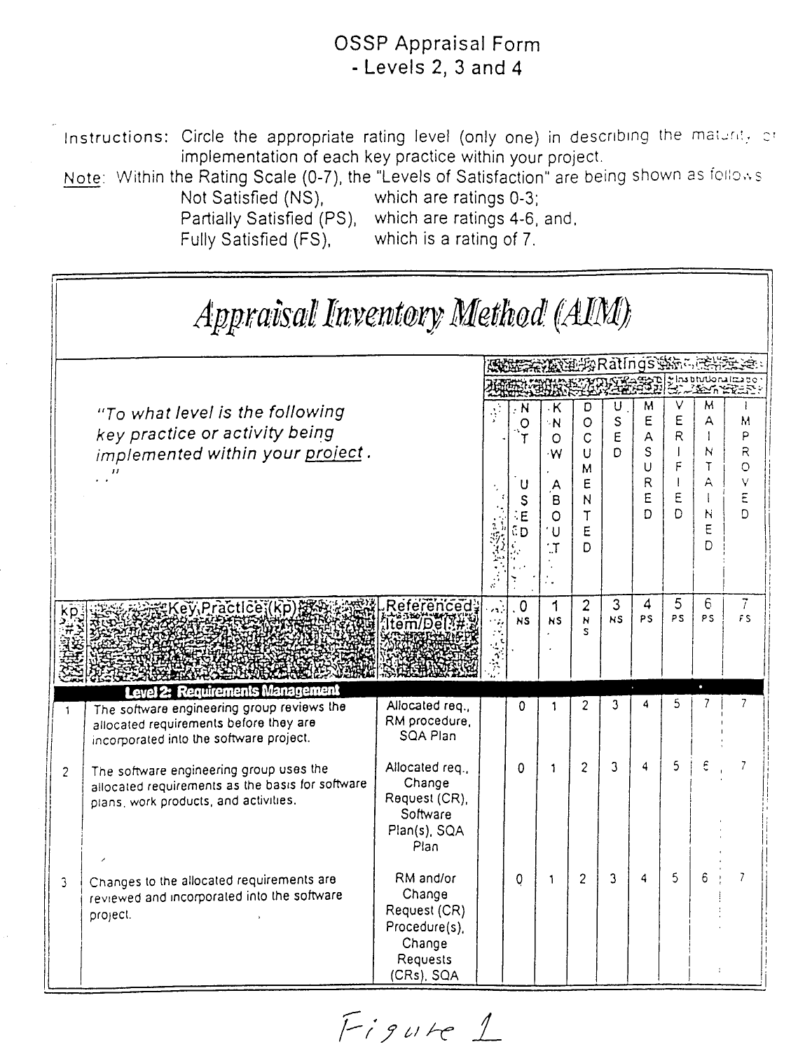

The chart is shown also in FIG. 1, illustrating a single step in assessing the lowest measured level (level 2) in the CMM. The lowest coarse level NS, for “Not Satisfied” is used for aspects that are not used in the project or are only beginning to be used. The division between the NS level and the and the intermediate level of “Partially Satisfied” is when the process is well enough developed to be measured. The first level of institutionalization starts at the next level, Verification, indicating that institutionalization requires that the process be developed sufficiently that this level of maturity has been reached. Those skilled in the art will appreciate that the particular choice of labels shown here for the levels of maturity is not essential and other sets of labels may be used that convey or express the meaning that the process is immature (Not Implemented); is fairly well along (Partially Implemented); and has reached a mature level (Fully Implemented) and the terms used in the following claims are meant to represent any equivalent label.

The process of institutionalization involves not only improving the software, but also documenting the product and the process of developing it to a degree such that the process is followed consistently, but also that it is sufficiently well documented that the departure of a single (key) person can be handled by reliance on the documentation i.e. a replacement can get up to speed in a reasonable amount of time without “re-inventing the wheel”.

This particular example has been chosen for the illustration to emphasize an aspect of the invention—the lowest level of the CMM can be awarded the highest level (“Fully Institutionalized”) according to the invention. Using an image from geometry, it could be said that the measurement system according to the invention is “orthogonal” to the CMM, meaning that, as in the previous sentence, many levels of the CMM can have different ratings according to the invention. For example, the process for Inter Group coordination (on Level 3 of the CMM) might be fully institutionalized while the process for subcontracting software (on the lowest Level 2 of the CMM) might need considerable additional work. Some features of the CMM depend on other features, so that there will be some cases where ratings according to the invention will also be linked, but the general rule is that there will be a mixture of ratings in an assessment according to the invention.

Preferably, the assessment starts at the lowest level of the CMM. If a lower level (3, say) of the CMM has not been fully institutionalized, higher levels need not be neolected. In the inventive process, it is not only possible, but preferable to work on several levels simultaneously. As an example, within the “Organization Process Focus” Key Process Area described within Level 3, a procedure according to the invention supports the following:

It is a feature of the invention that the ratings for a KPA according to the invention are sequential in the sense that lower rankings are building blocks for higher ones, as is explained more fully below.

If an appraisal form participant indicates that they are “fully” institutionalized” which is a rating of “7” in their implementation, then the assumption can be made that this key practice . . .

Rating 1: is known (they have heard about it)

Rating 2: is documented (e.g., either a handwritten procedure, deliverable, web page, online screen, etc.)

Rating 3: is being used by the project (It's not good enough to just have a deliverable documented it needs to be “up-to-date” and “put into action”!)

Rating 4: measurements are used to status the activities being performed for managing allocated requirements (one needs to be using the defined organizational measures from the SPD, and any other identified project-specific measures)

Rating 5: is being verified. Which is the first (1) step of institutionalization. Verifying implementation requires reviews by the Software Engineering Process Group (SEPG) and/or SQA.

Rating 6: is being maintained. Which is the second (2) step of institutionalization. Maintaining implies that training (e.g., formal and/or informal, work/support aids such as procedures are being promoted) is taking place surrounding this. Thus, even after those who originally defined them are gone, somebody will be able to take his/her place.

Rating 7: is being continuously improved. This final step (3) of institutionalization implies that the process has been in existence/used for at least six to twelve (6-12) months, and with the usage of both organizational and/or project-specific measures, improvements are being applied, as appropriate.

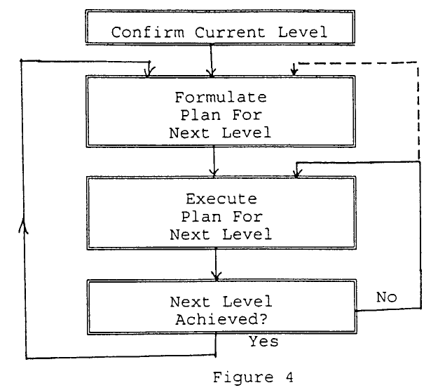

The software process is assessed periodically, and action plans are developed to address the assessment findings. FIG. 4 illustrates schematically an iterative procedure focusing on a single aspect of the software procedure. The dotted line on the right indicates that in some cases, it will be necessary to re-formulate the plan for the next level, in addition to persevering in the execution of the plan.

Preferably, the local SEPG will be called in to assist in the evaluation and/or improvement of the application of the organization's approved process to the particular project being assessed.

Practitioners in the art will note that an assessment according to the invention does not simply review the CMM model, but rather looks at the organization's software process from a different perspective. For example, a ratings of “4” according to the invention means that the process being assessed employs measurements to evaluate the status of the activities being performed by the development group. In contrast, the CMM introduces quantitative measurement in level 4. In a process according to the invention, a group that has achieved a rating of 4 will be using measurements from the start of a project.

Further, the first step of institutionalization, level 5, involves verifying, with the aid of the organization's SEPG, that the assessment level in question has been met. In addition, a rating of 6 in the inventive method means that training is used to institutionalize the process, though the CMM places training in its Level 3. This different placement reflects different understanding in the CMM and in the present system. In the CMM, training is used to teach users how to use the program; while according to the present invention, training is used to reinforce the software process in the minds of the development team to the extent that it becomes second nature.

In operation, a form such as that shown in FIG. 1 may be used, whether on paper or on a computer screen. The leftmost colunm references the KPA in question. The second colunm from the left repeats the capsule definition of the KPA taken from the CMM. The third colunm references the element of the total process, any relevant document associated with that KPA, and the relevant sub-group that is responsible for that KPA. An evaluator, e.g. the Project Manager will distribute paper forms or set up an evaluation program for computer-operating the evaluation process. The participants, members of the development team and a representative from the SEPG will then proceed through the form, assigning a ranking to each KPA. The set of columns on the right serve to record the ratings. An example of a set of KPAs is set forth in Table III. The columns on the right have been removed from this example to improve the clarity of the presentation by using larger type.

The set of ratings from the individual assessors may be combined by simple averaging or by a weighted average, since not all KPAs will have equal weight in the assessment. Optionally, a roundtable meeting may be used to produce a consensus rating.

FIG. 1 reproduces the question that is asked for each KPA:

“To what level is the following key practice or activity being implemented within your project?”

A related question that is asked in other parts of the form is:

“To what level is the following key practice or activity being implemented within your organization?”

An example of a KPA capsule description is: “The project's defined software process is developed by tailoring the organization's standard software process according to a documented procedure”. The thrust of the question as applied to the foregoing is: How far along is the institutionalization of complying with a documented procedure for modification of the particular process applied within this organization—on a scale ranging from “Not Used” to “Fully Institutionalized”? There is a clear conceptual difference between asking the foregoing question and asking questions directed at the result of the process e.g. how well the software works, how timely was it, how close to budget, etc.

On the right of FIG. 1, there is a row of nine columns for the indication of the rating of that particular KPA; i.e. the answer to the question. That particular format is not essential for the practice of the invention in its broader aspects and other formats, e.g. a single entry slot on a computer screen, a sliding arrow on a screen that the user moves with his mouse, etc.

The process followed is indicated graphically in FIG. 2, in which the assessment team evaluates the current status of the various KPAs. Having reached an assessment of the current status, the team or a sub-group formulates a plan to advance the level of the project to the next rating. That plan will usually include a number of sub-plans aimed at sub-groups within the team. The last step of documenting the procedure includes modifying existing procedures and plans, formulating new plans, etc.

Those skilled in the art will appreciate that the evaluation may be carried out by manipulating symbols on a computer screen instead of checking a box on a paper form. The phrase manipulating symbols means, for purposes of the attached claims, checking a box on a computer display, clicking a mouse pointer on a “radio button” displayed on the screen, typing a number in a designated location on the screen, etc.

Although the invention has been described with respect to a single embodiment, those skilled in the art will appreciate that other embodiments may be constructed within the spirit and scope of the following claims.

TABLE I
DEFINITIONS

Allocated Requirements: The subset of the system requirements that are to
be implemented in the software components of the system.
Audit: An independent examination of a work product or set of work
products to assess compliance with specifications, standard, contractual
agreements, etc.
CMM: Capability Maturity Model. A description of the stages through
which organizations evolve as they define, implement, measure, control
and improve their software processes.
Commitment: A pact that is freely assumed, visible, and expected to be
kept by all parties.
Configuration Item (CI) & Element (CE): An aggregation of hardware,
software, or both, That is designated for configuration management and
treated as a single entity in the configuration management process. A
lower partitioning of the configuration item can be performed. These lower
entities are called configuration elements or CEs.
Defect Prevention (DP): Level 5 Key Process Area. The purpose is to
identify the cause of defects and prevent them from recurring.
Documented Procedure: A written description of a course of action to be
taken to perform a given task.
Institutional/Institutionalization: The building of infrastructure and
corporate culture that support methods, practices and procedures so that
they are continuously verified, maintained and improved.
Integrated Software Management (ISM): Level 3 Key Process Area. The
purpose is to integrate the software engineering and management activities
into a coherent, defined software process that is tailored from the
organization's standard software process (OSSP) and related process
assets. Intergroup Coordination (IC): Level 3 Key Process Area. The
purpose is to establish a means for the software engineering group to
participate actively with the other engineering groups so the project is
better able to satisfy the customer's needs effectively and efficiently.
Key Practice: The infrastructures and activities that contribute most to the
effective implementation and institutionalization of a key process area.
There are key practices in the following common features: commitment to
perform ability to perform activities performed measurement and analysis
verifying implementation.
For interim appraisals, the key practices under “activities performed” will
be focused upon.
Measure/Measurements: The dimension, capacity, quantity, or amount of
something (such as number of defects). In the context of AIM,
measurements are made and used to determine the status of and manage
the key practices.
Organization Process Definition (OPD): Level 3 Key Process Area. The
purpose is to develop and maintain a usable set of software process assets
that improve process performance across the projects and provide a basis
for cumulative, long-term benefits to the organization. Involves developing
and maintaining the organization's standard software process (OSSP),
along with related process assets, such as software life cycles (SLC),
tailoring guidelines, organization's software process database (SPD), and a
library of software process-related documentation (PAL).
Organization Process Focus (OPF): Level 3 Key Process Area. The
purpose is to establish the organizational responsibility for software
process activities that improve the organization's overall software process
capability. Involves developing and maintaining an understanding of the
organization's and projects″ software processes and coordinating the
activities to assess, develop, maintain, and improves these processes.
OSSP: Organization Standard Software Process. An asset which identified
software process assets and their related process elements. The OSSP
points to other assets such as Tailoring, SPD, SLC, PAL and Training.
Thus, note ????OSSPer the pointer dog to the left.
PDSP: Project's Defined Software Process. The definition of the software
process used by a project. It is developed by tailoring the OSSP to fit the
specific characteristics of the project.
Peer Reviews (PR): Level 3 Key Process Area. A review of a software
work product, performed according to defined procedures, by peers of the
producers of the product for the purpose of identifying defects and
improvements.
Periodic Review/Activity: A review/activity that occurs at a specified
regular time interval, rather than at the completion of major events.
Process Asset Library (PAL): A library where “best practices” used on
past projects are stored. In general, the PAL contains any documents that
can be used as models or examples for future projects.
Process Change Management (PCM): Level 5 Key Process Area. The
purpose is to continually improve the software processes used in the
organization with the intent of improving software quality, increasing
productivity, and decreasing the cycle time for product development.
Project Manager: The role with total responsibility for all the software
activities for a project. The Project Manager is the individual who leads
the software engineering group (project team) in terms of planning,
controlling and tracking the building of a software system.
Quantitative Process Management (QPM): Level 4 Key Process Area.
Involves establishing goals for the performance of the project's defined
software process (PDSP), taking measurements of the process
perfommnce, analyzing these measurements, and making adjustments to
maintain process performance within acceptable limits.
Requirements Management (RM): Level 2 Key Process Area. Involves
establishing and maintaining an agreement with the customer of the
requirements for the software project. The agreement forms the basis for
estimating, planning, performing, and tracking the software project's
activities throughout the software life cycle.
Roles & Responsibilities (R&R): A project management deliverable that
describes the people and/or working groups assigned in supporting the
software project. This charter deliverable delineates the assigned
responsibility along with the listing of contacts for each team member or
group.
Senior Management: A management role at a high enough level in an
organization that the primary focus is the long-term vitality of the
organization (i.e., 1st-level or above).
Software Baseline: A set of configuration items that has been formally
reviewed and agreed upon, that thereafter serves as the basis for future
development, and that can be changed only through formal change control
procedures.
Software Configuration Management (SCM): Level 2 Key Process Area.
Purpose is to establish and maintain the integrity of the products of the
software project throughout the project's software life cycle. Involves
identifying the configuration of the software at given points in time,
controlling changes to the configuration, and maintaining the integrity and
traceability of the configuration the software life cycle.
Software Engineering Group (SEG): The part of the Project Team that
delivers software to the project. This includes, but is not limited to:
System Manager, Project Manager, Business Analysts, IS Analysts, SQE
Focals, CM Focals.
Software Engineering Institute (SEI): Developer/owner of the Capability
Maturity Model.
Software Engineering Process Group (SEPG): This group wmaintains,
documents and develops the various processes associated with software
development, as distinguished from the group responsible for creating the
software and will be responsible in facilitating the interim assessments as
requested or required (for software accreditation).
Software Life Cycle (SLC): The period of time that begins when a
software product is conceived and ends when the software is no longer
available for use.
Software Plans: The collection of plans, both formal and informal, used to
express how software development and/or maintenance activities will be
performed.
Software Process: A set of activities, methods, practices, and
transformations that people use to develop and maintain software and the
associated products. (e.g., project plans, design documents, code, test
cases, and user manuals).
Software Process Assessment: An appraisal by a trained team of software
professionals to determine the state of an organization's current software
process, to determine the high-priority software process-related issues
facing an organization, and to obtain the organizational support for
software process improvement.
Software Product Engineering (SPE): Level 3 Key Process Area. The
purpose of SPE is to consistently perform a well-defined engineering
process that integrates all the software engineering activities to produce
correct, consistent software products effectively and efficiently. This
includes using a project's defined software process to analyze system
requirements, develop the software architecture, design the software,
implement the software in the code, and test the software to verify that it
satisfies the specified requirements.
Software Project Planning (SPP): Level 2 Key Process Area. To establish
reasonable plans for performing the software engineering activities and for
managing the software project.
Software Project Tracking and Oversight (PTO): Level 2 Key Process
Area. To provide adequate visibility into actual progress so that
management can take corrective actions when the software project's
performance deviates significantly from the software plans. Involves
tracking and reviewing the software accomplishments and results against
documented estimates, commitments, and plans, and adjusting these plans
based on the actual accomplishments and results.
Software Subcontract Management (SSM): Level 2 Key Process Area. The
purpose is to select qualified software subcontractors and manage them
effectively. Involves selecting a software subcontractor, establishing
commitments with the subcontractor, and tracking and reviewing the
subcontractor's performance and results.
Software Process Database (SPD): A database established to collect and
make available data on the OSSP.
Software Quality Assurance (SQA): Level 2 Key Process Area. (1) A
planned and systematic pattern of all actions necessary to provide adequate
confidence that a software work product conforms to established technical
requirements. (2) A set of activities designed to evaluate the process by
which software work products are developed and/or maintained.
Software Quality Management (SQM): Level 4 Key Process Area.
Involves defining quality goals for the software products, establishing
plans to achieve these goals, monitoring and adjusting the software plans,
software work products, activities and quality goals to satisfy the needs
and desires of the customer for high-quality products.
Software Work Product: A deliverable created as part of defining,
maintaining, or using a project's defined software process, including
business process descriptions, plans, procedures, computer programs, and
associated documentation.
Standard: Mandatory requirements employed and enforced to prescribe a
disciplined, uniform approach to software development and maintenance.
Statement of Work (SOW): This project management deliverable clearly
defines the project manager's assignment and the environment in which
the project will be carried out. It defines the context, purpose, objectives
of the project, scope interfaces to others, project organization, outlines
major constraints and assumptions, the project plan and budget, critical
success factors, and impacts and risks to the project and organization.
Tailoring: The set of related elements that focus on modifying a process,
standard, or procedure to better match process or product requirements.
Technology Change Management (TCM): A Level 5 Key Process Area.
The purpose is to identify new technologies (i.e., tools, methods, and
processes) and track them into the organization in an orderly manner.
Training (TRN): Level 3 Key Process Area. The purpose of training is to
develop the skills and knowledge of individuals so they can perform their
roles effectively and efficiently.

TABLE II
RATING SCALE

| | | | | | | | | | | |
|---|---|---|---|---|---|---|---|---|---|---|
| | ?To what level is the following | | N | K | D | U | M | V | M | I |
| | key practice or activity being | | O | N | O | S | E | E | A | M |
| | implemented within your project | | T | O | C | E | A | R | I | P |
| | . . . ? | | | W | U | D | S | I | N | R |
| | | | | | M | | U | F | T | O |
| | | | U | A | E | | R | I | A | V |
| | | | S | B | N | | E | E | I | E |
| | | | E | O | T | | D | D | N | D |
| | | | D | U | E | | | | E | |
| | | | | T | D | | | | D | |
| k | Key Practice (kp) | Referenced | 0 | 1 | 2 | 3 | 4 | 5 | 6 | 7 |
| p | | Item/Del. | N | N | N | N | P | P | P | F |
| # | | # | S | S | S | S | S | S | S | S |

TABLE III
LIST OF ASSESSMENT QUESTIONS
Level 2: Requirements Management

| | | |
|---|---|---|
| 1 | The software engineering group reviews the allocated | Allocated req., |
| | requirements before they are incorporated into the | RM procedure, |
| | software project. | SQA Plan |
| 2 | The software engineering group uses the allocated | Allocated req., |
| | requirements as the basis for software plans, work | Change Request |
| | products, and activities. | (CR), Software |
| | | Plan(s), SQA |
| | | Plan |
| 3 | Changes to the allocated requirements are reviewed and | RM and/or |
| | incorporated into the software project. | Change Request |
| | | (CR) |
| | | Procedure(s), |
| | | Change Requests |
| | | (CRs), SQA Plan |

Level 2: Software Project Planning

| | | |
|---|---|---|
| 1 | The software engineering group participates on the | R&R, SOW, |
| | project proposal team. | SQA Plan |
| 2 | Software project planning is initiated in the early stages | Overall Project |
| | of, and in parallel with, the overall project planning | Plan, Software |
| | | Plan(s), SQA |
| | | Plan |
| 3 | The software engineering group participates with other | SOW, R&R, |
| | affected groups in the overall project planning | Project Review |
| | throughout the project's life. | Minutes, SQA |
| | | Plan |
| 4 | Software project commitments made to individuals and | R&R, Status |
| | groups external to the organization are reviewed with | Review/Reports |
| | senior management according to a documented | Procedure, |
| | procedure. | Minutes, SQA |
| | | Plan |
| 5 | A software life cycle with predefined stages of | Stages of SLC |
| | manageable size is. identified or defined. | within Software |
| | | Plan(s), SQA |
| | | Plan |
| 6 | The project's software development plan is developed | Software Plan(s), |
| | according to a documented procedure. | Procedure, SQA |
| | | Plan |
| 7 | The plan for the software project is documented. | Software Plan(s), |
| | | SQA Plan |
| 8 | Software work products that are needed to establish and | List of Software |
| | maintain control of the software project are identified. | Work Products |
| | | (CIs), SQA Plan |
| 9 | Estimates for the size of the software work products (or | Estimating |
| | changes to the size of work products) are derived | Procedure, SQA |
| | according to a documented procedure | Plan |
| 10 | Estimates for the software project's effort and costs are | Estimating |
| | derived according to a documented procedure. | Procedure, SQA |
| | | Plan |
| 11 | Estimates for the project's critical computer resources are | Estimating |
| | derived according to a documented procedure. | Procedure, SQA |
| | | Plan |
| 12 | The project's software schedule is derived according to a | Estimating |
| | documented procedure. | Procedure, |
| | | Software |
| | | Schedule, SQA |
| | | Plan |
| 13 | The software risks associated with the cost, resource, | SOW, Risk |
| | schedule, and technical aspects of the project are | Report, SQA |
| | identified, assessed, and documented. | Plan |
| 14 | Plans for the project's software engineering facilities and | Facilities & |
| | support tools are prepared. | Support Tools |
| | | Plan, SQA Plan |
| 15 | Software planning data are recorded. | Software Plan(s)/ |
| | | Reports, SQA |
| | | Plan |

Level 2: Software Project Tracking and Oversight

| | | |
|---|---|---|
| 1 | A documented software development plan is used for | Software Plan(s), |
| | tracking the software activities and communicating | Stastus Reports, |
| | status. | SQA Plan |
| 2 | The project's software development plan is revised | Software Plan |
| | according to a documented procedure. | Procedure, CR |
| | | Procedure, SQA |
| | | Plan |
| 3 | Software project commitments and changes to | R&R procedure, |
| | commitments made to individuals and groups external to | Status Reviews, |
| | the organization are reviewed with senior management | “Changes to |
| | according to a documented procedure. | Commitment” |
| | | Report, SQA |
| | | Plan |
| 4 | Approved changes to conimitments that affect the | Change Notices, |
| | software project are communicated to the members of | SQA Plan |
| | the software engineering group and other software- | |
| | related groups. | |
| 5 | The size of the software work products (or size of the | Software Plans |
| | changes to the software work products) are tracked, and | Tracking Report, |
| | corrective actions are taken as necessary. | SQA Plan |
| 6 | The project's software effort and costs are tracked, and | Software Plans |
| | corrective actions are taken as necessary. | Tracking Report, |
| | | SQA Plan |
| 7 | The project's critical computer resources are tracked, and | Software Plans |
| | corrective actions are taken as necessary. | Tracking Report, |
| | | SQA Plan |
| 8 | The project's software schedule is tracked, and corrective | Software Plans |
| | actions are taken as necessary. | Tracking Report, |
| | | SQA Plan |
| 9 | Software engineering technical activities are tracked, and | Software Plans |
| | corrective actions are taken as necessary. | Tracking Report, |
| | | SQA Plan |
| 10 | The software risks associated with cost, resource, | Risk Plan, |
| | schedule, and technical aspects of the project are | Software Plans |
| | tracked. | Tracking Report, |
| | | SQA Plan |
| 11 | Actual measurement data and replanning data for the | Measurement |
| | software project are recorded. | Plan, Meas. |
| | | Reports |
| 12 | The software engineering group conducts periodic | Technical |
| | internal reviews to track technical progress, plans, | Review Reports, |
| | performance, and issues against the software | SQA Plan |
| | development plan. | |
| 13 | Formal reviews to address the accomplishments and | Status Review |
| | results of the software project are conducted at selected | Procedure, Status |
| | project milestones according to a documented procedure. | Review Rpts, |
| | | SQA Plan |

Level 2: Software Subcontract Management

| | | |
|---|---|---|
| 1 | The work to be subcontracted is defined and planned | SubC Procedure, |
| | according to a documented procedure. | Project Plan, |
| | | SQA Plan |
| 2 | The software subcontractor is selected, based on an | SubC Procedure, |
| | evaluation of the subcontract bidder's ability to perform | Selection Rpt., |
| | the work, according to a documented procedure. | SQA Plan |
| 3 | The contractual agreement between the prime contractor | SubC Procedure, |
| | and the software subcontractor is used as the basis for | Contractual |
| | managing the subcontract. | Agreement, SQA |
| | | Plan |
| 4 | A documented subcontractor's software development | SubC Procedure, |
| | plan is reviewed and approved by the prime contractor. | SubC Dev. Plan, |
| | | SQA Plan |
| 5 | A documented and approved subcontractor's software | SubC Procedure, |
| | development plan is used for tracking the software | Tracking Rpt., |
| | activities and communication of status. | SQA Plan |
| 6 | Changes to the software subcontractor's statement of | SubC Procedure, |
| | work, subcontract terms and conditions, and other | Change Records, |
| | commitments are resolved according to a documented | SubC SOW |
| | procedure. | |
| 7 | The prime contractor's management conducts periodic | SubC Procedure, |
| | status/coordination reviews with the software | Status Rpt(s), |
| | subcontractor's management. | SQA Plan |
| 8 | Periodic technical reviews and interchanges are held | SubC Procedure, |
| | with the software subcontractor. | Technical |
| | | Review Rpt(s), |
| | | SQA Plan |
| 9 | Formal reviews to address the subcontractor's software | SubC Procedure, |
| | engineering accomplishments and results are conducted | Status Rpt(s), |
| | at selected milestones according to a documented | SQA Plan |
| | procedure. | |
| 10 | The prime contractor's software quality assurance group | SubC Procedure, |
| | monitors the subcontractor's software quality assurance | SQA |
| | activities according to a documented plan. | PLANPlan/Rpt(s), |
| | | SQA Plan |
| 11 | The prime contractor's software configuration | SubC Procedure, |
| | management group monitors the subcontractor's | SCM |
| | activities for software configuration management | Plan/Rpt(s), SQA |
| | according to a documented procedure. | Plan |
| 12 | The prime contractor conducts acceptance testing as part | SubC Procedure, |
| | of the delivery of subcontractor's software products | Testing Plan & |
| | according to a documented procedure. | Rpt(s), SQA Plan |
| 13 | The software subcontractor's performance is evaluated | SubC Procedure, |
| | on a periodic basis, and the evaluation is reviewed with | Status Rpt(s), |
| | the subcontractor. | Evaluation |
| | | Records, SQA |
| | | Plan |

Level 2: Software Quality Assurance

| | | |
|---|---|---|
| 1 | A SQA plan is prepared for the software project | SQA Plan |
| | according to a documented procedure. | Procedure, SQA |
| | | Plan |
| 2 | The SQA group's activities are performed in accordance | R&R, SQA Plan |
| | with the SQA plan | |
| 3 | The SQA group participates in the preparation and | SQA Plan, |
| | review of the project's software development plan, | Technical |
| | standards, and procedures. | Review Rpt |
| 4 | The SQA group reviews the software engineering | SQA Audit Rpt, |
| | activities to verify compliance. | Issue(s) |
| 5 | The SQA group audits designated software work | SQA Audit Rpt, |
| | products to verify compliance | Issue(s) |
| 6 | The SQA group periodically reports the results of its | SQA Audit Rpt. |
| | activities to the software engineering group. | |
| 7 | Deviations identified in the software activities and | NonCompliance |
| | software work products are documented and handled | Procedure, |
| | according to a documented procedure. | Issue(s) |
| 8 | The SQA group conducts periodic reviews of its | SQA Audit Rpt., |
| | activities and findings with the customer's SQA | Review Records |
| | personnel, as appropriate. | |

Level 2: Software Configuration Management

| | | |
|---|---|---|
| 1 | A SCM plan is prepared for each software project | SCM Plan |
| | according to a documented procedure. | Procedure, SCM |
| | | Plan, SQA Plan |
| 2 | A documented and approved SCM plan is used as the | SCM Plan, SQA |
| | basis for performing the SCM activities. | Plan |
| 3 | A configuration management library system is | Initial Listing of |
| | established as a repository for the software baselines. | CIs/CEs, SQA |
| | | Plan |
| 4 | The software work products to be placed under | WBS, Targeted |
| | configuration management are identified. | CIs/CEs, SQA |
| | | Plan |
| 5 | Change requests and problem reports for all | CR Procedure, |
| | configuration items/units are initiated, recorded, | CRs, Problem |
| | reviewed, approved, and tracked according to a | Rpt Procedure, |
| | documented procedure. | Problem Rpts, |
| | | SQA Plan |
| 6 | Changes to baselines are controlled according to a | CR Procedure, |
| | documented procedure. | SQA Plan |
| 7 | Products from the software baseline library are created | SCM Release |
| | and their release is controlled according to a documented | Plan or Software |
| | procedure. | Plan per it's |
| | | procedure, SQA |
| | | Plan |
| 8 | The status of configuration items/units is recorded | SCM Plan, Status |
| | according to a documented procedure. | Reports, SQA |
| | | Plan |
| 9 | Standard reports documenting the SCM activities and the | CCB Minutes |
| | contents of the software baseline are developed and | SCM Plan, |
| | made available to affected groups and individuals. | Software Plan, |
| | | SQA Plan |
| 10 | Software baseline audits are conducted according to a | CM Audit |
| | documented procedure. | Procedure or |
| | | SQA Plan (which |
| | | includes CM), |
| | | Audit Records |
| | | and/or Minutes, |
| | | SQA Plan |

Level 3: Organization Process Focus

| | | |
|---|---|---|
| 1 | The software process is assessed | Assessments by SEPG, |
| | periodically, and action plans are | results and action plans |
| | developed to address the assessment | |
| | findings. | |
| 2 | The organization develops and maintains | SEPG's SOW and project |
| | a plan for its software process | plan(s) (includes resources |
| | development and improvement activities. | & SPI policies) |
| 3 | The organization's and projects″ activities | SEPG's SOW, project plans |
| | for developing and improving their | |
| | software processes are coordinated at the | |
| | organization level. | |
| 4 | The use of the organization's software | SEPG's SOW |
| | process database (SPD) is coordinated at | |
| | the organizational level. | |
| 5 | New processes, methods, and tools in | SPIN's, |
| | limited use in the organization are | PAL, |
| | monitored, evaluated, and where | SPD, pilot and deployment |
| | appropriate, transferred to other parts of | plans |
| | the organization. | |
| 6 | Training for the organization's and | Organization's Training Plan |
| | project's software processes is coordinated | |
| | across the organization. | |
| 7 | The groups involved in implementing the | SPIN's & SEPG Information |
| | software processes are informed of the | Share Meetings, OSSP |
| | organization's and project's activities for | Directory |
| | software process development and | |
| | improvement. | |

Level 3: Organization Process Definition

| | | |
|---|---|---|
| 1 | The organization's standard software | OSSP Change Control |
| | process (OSSP) is developed and | Procedure, Change Records |
| | maintained according to a documented | |
| | procedure. | |
| 2 | The organization's standard software | Established organization |
| | process is documented according to | standards for software |
| | established organization standards. | process |
| 3 | Descriptions of software-life cycles that | Software life cycle |
| | are approved for use by the projects are | descriptions |
| | documented and maintained. | |
| 4 | Guidelines and criteria for the project's | Software process tailoring |
| | tailoring of the organization's standard | guidelines and criteria |
| | software process are developed and | |
| | maintained. | |
| 5 | The organization's software process Organization's SPD | |
| | database is established and maintained. | |
| 6 | A library of software process-related | Software Process-related |
| | documentation is established and | document library (PAL) |
| | maintained. | |

Level 3: Training

| | | |
|---|---|---|
| 2 | The organization's training plan is | OSSP Change Control |
| | developed and revised according to a | Procedure perhaps tailored |
| | documented procedure | for training, Organization |
| | Training Plan | |
| 3 | The training for the organization is | Performance Management |
| | performed in accordance with the | plans, Organization's |
| | organization's training plan. | Training Plans & Records |
| 4 | Training courses prepared at the | Organization Standards for |
| | organizational level are developed and | Training Courses |
| | maintained according to organization | |
| | standards. | |
| 5 | A waiver procedure for required training | Waiver Procedure, Waiver |
| | is established and used to determine | records |
| | whether individuals already possess the | |
| | knowledge and skills required to perform | |
| | in their designated roles. | |
| 6 | Records of training are maintained. | Training Records |

Level 3: Training

| | | |
|---|---|---|
| 1 | Each software project develops and | Project Training Plan, SQA |
| | maintains a training plan that specifies its | Plan |
| | training needs. | |

Level 3: Integrated Software Management

| | | |
|---|---|---|
| 1 | The project's defined software process is | OSSP Tailoring Guidelines |
| | developed by tailoring the organization's | or Procedure, PDSP, SQA |
| | standard software process according to a | Plan |
| | documented procedure. | |
| 2 | Each project's defined software process is | OSSP Tailoring Procedure, |
| | revised according to a documented | PDSP, Change Records, |
| | procedure. | SQA Plan |
| 3 | The project's software development plan, | Software Plan(s) and |
| | which describes the use of the project's | Procedure, SQA Plan |
| | defined software process, is developed | |
| | and revised according to a documented | |
| | procedure. | |
| 4 | The software project is managed in | PDSP, Software Plan(s), |
| | accordance with the project's defined | SQA Plan |
| | software process. | |
| 5 | The organization's software process | SPD, Software Plan(s), |
| | database is used for software planning and | Estimating Procedure, SQA |
| | estimating. | Plan |
| 6 | The size of the software work products (or | # of Project Elements (CIs |
| | size of changes to the software work | or CEs), Source Lines of |
| | products) is managed according to a | Code, Function Points per |
| | documented procedure. | their Estimating Procedure, |
| | | Measurement Plan, SQA |
| | | Plan |
| 7 | The project's software effort and costs are | Progress Review Reports, |
| | managed according to a documented | Project Review Report |
| | procedure. | Procedure(s), SQA Plan |
| 8 | The project's critical computer resources | Resource Allocated/Used |
| | are managed according to a documented | Document, Progress and |
| | procedure. | Project Reviews and |
| | | Reports, SQA Plan |
| 9 | The critical dependencies and critical | Software Planning |
| | paths of the project's software schedule | Procedure, Software Plan(s), |
| | are managed according to a documented | SQA Plan |
| | procedure. | |
| 10 | The project's software risks are identified, | Risk Management |
| | assessed, documented, and managed | Procedure, Risk documents, |
| | according to a documented procedure. | SQA Plan |
| 11 | Reviews of the software project are | Progress/Project Reviews |
| | periodically performed to determine the | and Reports, SQA Plan |
| | actions needed to bring the software | |
| | project's performance and results in line | |
| | with the current and projected needs of | |
| | the business, customer, and end users, as | |
| | appropriate. | |

Level 3: Software Product Engineering

| | | |
|---|---|---|
| 1 | Appropriate software engineering | Environment and Support |
| | methods and tools are integrated into the | Tools Plan, SQA Plan |
| | project's defincd software process. | |
| 2 | The software requirements are developed, | RM Documents and |
| | maintained, documented and verified by | Procedure, Change Records, |
| | systematically analyzing the allocated | Peer Review Recordds, SQA |
| | requirements according to the project's | Plan |
| | defined software process. | |
| 3 | The software design is developed, | Design Documents, SQA |
| | maintained, documented, and verified | Plan |
| | according to the project's defined software | |
| | process, to accommodate the software | |
| | requirements and to form the framework | |
| | for coding. | |
| 4 | The software code is developed, | Code, Change Reoords, Peer |
| | maintained, documented, and verified, | Review Records, SQA Plan |
| | according to the project's defined software | |
| | process, to implement the software | |
| | requirements and software design. | |
| 5 | Software testing is performed according | Test Plan(s) and Reports, |
| | to the project's defined software process. | Test Change Records, Peer |
| | | Review Records, SQA Plan |
| 6 | Integration testing of the software is | Integration Test Plan(s) and |
| | planned and performed according to the | Reports, SQA Plan |
| | project's defined software process. | |
| 7 | System and acceptance testing of the | Test and Acceptance |
| | software are planned and performed to | Plan(s), SQA Plan |
| | demonstrate that the software satisfies its | |
| | requirements. | |
| 8 | The documentation that will be used to | Software Documentation, |
| | operate and maintain the software is | Change Records, Peer |
| | developed and maintained according to | Review Records, SQA Plan |
| | the project's defined software process. | |
| 9 | Data on defects identified in peer reviews | Defect Report(s), SQA |
| | and testing are collected and analyzed | |
| | according to the project's defined software | |
| | process. | |
| 10 | Consistency is maintained across software | Software Work Product |
| | work products, including software plans, | Descriptions, “ility” |
| | process descriptions, allocated | Criteria and Records” |
| | requirements, software requirements, | Testability, Traceabliity, |
| | software design, code, test plans, and test | Quality, SQA Plan |
| | procedures. | |

Level 3: Intergroup Coordination

| | | |
|---|---|---|
| 1 | The software engineering group and other | R & R Charter and/or |
| | engineering groups participate with the | System Requirements, SQA |
| | customer and end users, as appropriate, to | Plan |
| | establish the system requirements. | |
| 2 | Representatives of the projects software | Technical Review Reports, |
| | engineering group work with | Status Reports, SQA Plan |
| | representatives of the other engineering | |
| | groups to monitor and coordinate | |
| | technical activities and resolve technical | |
| | issues. | |
| 3 | A documented plan is used to | Software Plans, R & R |
| | communicate intergroup commitments | Charter, Progress/Project |
| | and to coordinate and track the work | Reviews & Reports, SQA |
| | performed. | Plan |
| 4 | Critical dependencies between | Software Plans, SQA Plan |
| | engineering groups are identified, | |
| | negotiated, and tracked according to a | |
| | documented procedure. | |
| 5 | Work products produced as input to other | Review Reports and/or |
| | engineering groups are reviewed by | Minutes, SQA Plan |
| | representatives of the receiving groups to | |
| | ensure that they meet their needs. | |
| 6 | Intergroup issues not resolvable by the | Issue Resolution Procedure, |
| | individual representatives of the project | Issue Records, SQA Plan |
| | engineering groups are handled according | |
| | to a documented procedure. | |
| 7 | Representatives of the project engineering | Technical Review Reports, |
| | groups conduct periodic technical reviews | SQA Plan |
| | & interchanges. | |

Level 3: Peer Reviews

| | | |
|---|---|---|
| 1 | Peer Reviews are planned & the plans | Software Plan(s), SQA Plan |
| | documented. | |
| 2 | Peer Reviews are performed according to | Peer Review Procedure, |
| | a documented procedure | Peer Review Minutes, SQA |
| | | Plan |
| 3 | Data on the conduct and results of the | Peer Review Data, SQA |
| | peer reviews are recorded. | Plan |

Level 4: Quantitative Process Management

| | | |
|---|---|---|
| 1 | The software project's plan for | QPM Plan Procedure, |
| | quantitative process management is | SQA |
| | developed according to a documented | |
| | procedure. | |
| 2 | The software project's quantitative | QPM Plan, SQA |
| | process management activities are | |
| | performed in accordance with the project's | |
| | quantitative process management plan. | |
| 3 | The strategy of the data collection and the | QPM Plan, SQA |
| | quantitative analysis to be performed are | |
| | determined based on the project's defined | |
| | software process (PDSP). | |
| 4 | The measurement data used to control the | QPM Plan, Measurement |
| | project's defined software process (PDSP) | Data, SQA |
| | quantitatively are collected according to a | |
| | documented procedure. | |
| 5 | The project's defined software process | QPM Plan and Reports, |
| | (PDSP) is analyzed and brought under | SQA |
| | quantitative control according to a | |
| | documented procedure. | |
| 6 | Reports documenting the results of the | QPM Reports, SQA |
| | software project's quantitative process | |
| | management activities are prepared and | |
| | distributed. | |
| 7 | The process capability baseline for the | |
| | organization's standard software process | |
| | (OSSP) is established and maintained | |
| | according to a documented procedure. | |

Level 4: Software Quality Management

| | | |
|---|---|---|
| 1 | The project's software quality plan is | Software Quality (SQ) Plan |
| | developed and maintained according to a | Procedure, SQ Plan, SQA |
| | documented procedure. | |
| 2 | The project's software quality plan is the | SQ Plan, SQA |
| | basis of the project's activities for | |
| | software quality management. | |
| 3 | The project's quantitative quality goals for | Goals within the Software |
| | the software products are defined, | Quality (SQ) Plan, Change |
| | monitored, and revised throughout the | Records, SQA |
| | software life cycle. | |
| 4 | The quality of the project's software | Evaluation Reports which |
| | products is measured, analyzed, and | include Measurement data, |
| | compared to the products″ quantitative | SQA |
| | quality goals on an event-driven basis. | |
| 5 | The software project's quantitative quality | Quality Goals as defined in |
| | goals for the products are allocated | the SubC Procedure |
| | appropriately to the subcontractors | |
| | delivering software products to the | |
| | project. | |

Level 5: Defect Prevention

| | | |
|---|---|---|
| 1 | The software project develops and | Defect Prevention Plan, |
| | maintains a plan for its defect prevention | Change Records, SQA |
| | activities. | |
| 2 | At the beginning of a software task, the | Kick Off Meeting Minutes |
| | members of the team performing the task | or Reports, List of Errors, |
| | meet to prepare for the activities of that | SQA |
| | task and the related defect prevention | |
| | activities. | |
| 3 | Causal analysis meetings are conducted | Causal Analysis Procedure, |
| | according to a documented procedure. | Meeting Minutes, Causal |
| | | Analysis Reports (e.g., CA |
| | | Diagrams), Defect Reports, |
| | | SQA |
| 4 | Each of the teams assigned to coordinate | Action Plans, Status |
| | defect prevention activities meets on a | Reports, Change Requests, |
| | periodic basis to review and coordinate | SQA |
| | implementation of action proposals from | |
| | the causal analysis meetings. | |
| 5 | Defect prevention data are documented | Defect Prevention Data |
| | and tracked across the teams coordinating | Reports, Status Reports, |
| | defect prevention activities. | SQA |
| 6 | Revisions to the organization's standard | OSSP Change Control |
| | software process resulting from defect | Process, Change Records, |
| | prevention actions are incorporated | SQA |
| | according to a documented procedure. | |
| 7 | Revisions to the project's defined software | Project's Change Control |
| | process resulting from defect prevention | Procedure, Change Records, |
| | actions are incorporated according to a | SQA |
| | documented procedure. | |
| 8 | Members of the software engineering | Feedback Reports (e.g., |
| | group and software-related groups receive | electronic bulletin boards, |
| | feedback on the status and results of the | newsletters, meetings), SQA |
| | organization's and project's defect | |
| | prevention activities on a periodic basis. | |

Level 5: Technology Change Management

| | | |
|---|---|---|
| 1 | The organization develops and maintains | TCM Plan, TCM Change |
| | a plan for technology change | Records as part of OSSP |
| | management. | Change Control Procedure, |
| | | SQA |
| 2 | The group responsible for the | Technology Change |
| | organization's technology change | Suggestions, TC Group |
| | management activities works with the | Charter |
| | software projects in identifying areas of | |
| | technology change. | |
| 3 | Software managers and technical staff are | Examples - electronic |
| | kept informed of new technologies, | bulletin boards, newsletters, |
| | | meetings), SQA |
| 4 | The group responsible for the | Evaluation/Analyis Reports |
| | organization's technology change | of standard software |
| | management systematically analyzes the | process, Change Records, |
| | organzation's standard software process to | SQA |
| | identify areas that need or could benefit | |
| | from new technology. | |
| 5 | Technologies are selected and acquired | Technology/Architecture |
| | for the organization and software projects | Selection and Acquisition |
| | according to a documented procedure. | Procedure, SQA |
| 6 | Pilot efforts for improving technology are | Pilot plans of selected |
| | conducted, where appropriate, before a | technology, SQA |
| | new technology is introduced into normal | |
| | practice. | |
| 7 | Appropriate new technologies are | OSSP Change Control |
| | incorporated into the organization's | Procedure, Change Records, |
| | standard software process according to a | SQA |
| | documented procedure. | |
| 8 | Appropriate new technologies are | Project's Change Control |
| | incorporated into the projects' defined | and/or RM Procedure, |
| | software processes according to a | Change Records, SQA |
| | documented procedure. | |

Level 5: Process Change Management

| | | |
|---|---|---|
| 1 | A software process improvement program | SPI Policy/Standard(s), SPI |
| | is established which empowers the | Charter |
| | members of the organization to improve | |
| | the processes of the organization. | |
| 2 | The group responsible for the | Organization's/SEPG's SPI |
| | organization's software process activities | Plan(s), SEPG Charter, SQA |
| | coordinates the software process | |
| | improvement activities | |
| 3 | The organization develops and maintains | SPI Plan(s), OSSP Change |
| | a plan for software process improvement | Control Procedure, Change |
| | according to a documented procedure. | Records, SEPG Charter, |
| | | SQA |
| 4 | The software process improvement | SPI Plan, Tracking/Status |
| | activities are performed in accordance | Reports, SQA |
| | with the software process improvement | |
| | plan. | |
| 5 | Software process improvement proposals | OSSP Change Control |
| | are handled according to a documented | Procedure, Change Records, |
| | procedure. | SEPG Planning |
| | | Procedure(s), Status Review |
| | | Reporting, SQA |
| 6 | Members of the organization actively | Quality entries on |
| | participate in teams to develop software | Performance Management |
| | process improvements for assigned areas. | Plans, Process Improvement |
| | | Team Plans, Status Reviews, |
| | | SQA |
| 7 | Where appropriate, the software process | Pilot Plans, Results, SQA |
| | improvements are installed on a pilot | |
| | basis to determine their benefits and | |
| | effectiveness before they are introduced | |
| | into normal practice. | |
| 8 | When the decision is made to transfer a | SEPG Plan(s), OSSP |
| | software process improvement into | Change Procedure, Change |
| | normal practice, the improvement is | Records, SQA |
| | implemented according to a documented | |
| | procedure. | |
| 9 | Records of software process improvement | OSSP Change Records, |
| | activities are maintained. | SEPG/SPI Plans, Status |
| | | Review Minutes and/or |
| | | Reports, Measurement Data, |
| | | SQA |
| 10 | Software managers and technical staff | Feedback Mediums″ (e.g., |
| | receive feedback on the status and results | electronic bulletin boards, |
| | of the software process improvement | newsletters, meetings), SQA |
| | activities on an event-driven basis. | |

I claim:

1. A method of assessing the application of a software management process implementing the CMM to a project, comprising the steps of:
a) Selecting an ith level of the CMM model;
b) Selecting a jth sub-level in said ith level;
c) Selecting a KPA in said jth sub-level;
d) Assigning a rating assessing the level of maturity in said project of said KPA;
e) Recording said rating; and
f) Repeating steps a) through e) until all KPAs in the CMM have been assessed and corresponding ratings have been recorded.

2. A method according to claim 1, in which each level in step a) is selected sequentially.

3. A method according to claim 2, in which each sub-level in step b) is selected sequentially.

4. A method according to claim 1, in which at least one of said steps a) through c) is performed non-sequentially.

5. A method according to claim 1, in which said rating in step d) is selected from the group consisting of “Not Implemented”, “Partially Implemented” and “Fully Implemented” and said rating of “Not Implemented” is divided into sub-ratings ranging from a lowest rating indicating that that aspect is not used in the project to a rating indicating that that aspect is used.

6. A method according to claim 5, in which said rating of “Partially Implemented” in step d) is divided into sub-ratings ranging from “Measured” to “Maintained”.

7. A method according to claim 1, in which a KPA is displayed on a display device controlled by a data processing system and an evaluator carrying out the method performs any of said steps a) through e) by manipulating symbols on said display device.

8. A method according to claim 1, in which a combined rating of said jth sub-level is formed by calculating a weighted average of KPA ratings in said jth sub-level with a set of stored weights assigned to each KPA.

9. A method according to claim 7, in which a combined rating of said jth sub-level is formed by calculating a weighted average of KPA ratings in said jth sub-level with a set of stored weights assigned to each KPA.

10. A method of improving the application of a software management process implementing the CMM to a project, comprising the steps of:
a) Selecting an ith level of the CMM model;
b) Selecting a jth sub-level in said ith level;
c) Selecting a KPA in said jth sub-level;
d) Assigning a rating assessing the level of maturity in said project of said KPA;
e) formulating and documenting a plan to improve said rating number; and
f) Repeating steps a) through e) until all KPAs in the CMM have been assessed and corresponding plans have been formulated and documented.

11. A method according to claim 10, in which each level in step a) is selected sequentially.

12. A method according to claim 11, in which each sub-level in step b) is selected sequentially.

13. A method according to claim 10, in which at least one of said steps a) through c) is performed non-sequentially.

14. A method according to claim 10, in which said rating in step d) is selected from the group consisting of “Not Implemented”, “Partially Implemented” and “Fully Implemented” and said rating of “Not Implemented” is divided into sub-ratings ranging from a lowest rating indicating that that aspect is not used in the project to a rating indicating that that aspect is used.

15. A method according to claim 14, in which said rating of “Partially Implemented” in step d) is divided into sub-ratings ranging from “Measured” to “Maintained”.

16. A method according to claim 10, in which a KPA is displayed on a display device controlled by a data processing system and an evaluator carrying out the method performs any of said steps a) through e) by manipulating symbols on said display device.

17. A method according to claim 10, in which a combined rating of said jth sub-level is formed by calculating a weighted average of KPA ratings in said jth sub-level with a set of stored weights assigned to each KPA.

18. A method according to claim 16, in which a combined rating of said jth sub-level is formed by calculating a weighted average of KPA ratings in said jth sub-level with a set of stored weights assigned to each KPA.
